(19) United States
(12) Patent Application Publication
(10) Pub. No.: US 2020/0327507 A1
(43) Pub. Date: Oct. 15, 2020

(54) Method and Device for Creating Verified and Acknowledged Digital Employment Business Records

(71) Applicant: Konstantine George Paschalidis, Fort Lee, NJ (US)

(72) Inventor: Konstantine George Paschalidis, Fort Lee, NJ (US)

(21) Appl. No.: 16/382,009

(22) Filed: Apr. 11, 2019

(51) Int. Cl. G06Q 10/10

(52) U.S. Cl. CPC G06Q 10/1091; G06Q 10/1053

(57) ABSTRACT

A method and system for managing the attendance of employees and the associated payroll, as well as other human resources functions. An employee management system comprises a computer server attached to a database where an adaptive record is stored for each employee. An employer device runs an application and interfaces with the computer server, receiving input from an employer. A connected employee device runs its own application, receiving attendance data from an employee. Employees working at multiple sites transmit times of arrival and departure, as well as self-photographs verifying that data, to the computer server. The computer server generates queries regarding the correctness of the collected information. The employee reviews the queries and acknowledges their veracity by transmitting her or his confirmation signature. The employee management system tracks employee attendance, paid time off and benefits. The system creates verified and acknowledged digital employment records for use in audits and litigation.

### CROSS-REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### FIELD OF THE INVENTION

This invention relates to a system and method for tracking and verifying the time and attendance of employees at multiple locations.

### BACKGROUND ART

This section provides background information related to the present disclosure which is not necessarily prior art.

Gathering data on the amount of time that an employee has worked or spent time at a particular work site is critical for employers who need to generate business records based on employee attendance and financial matters, such as the amount of overtime paid to an employee. In general, the art of the invention is employee time-tracking tools and systems, which capture the time that an employee has arrived at a particular location at the start of said employee's work shift, and the time that said employee has left that particular location at the end of his or her shift.

It is known in the art to have an employee perform a check-in at the time of arrival to work, and a check-out thereafter upon leaving. Traditionally, time-clock systems using a punch card, or something similar, have been used to keep track of employee attendance in a variety of different industries, including manufacturing, agriculture, service, and retail, as well as others. These manual time-clock systems have been quickly replaced by computerized time-clock systems. In the case of computerized time-clock systems, the clocking in and out of work has been replaced with the employee logging in and logging out of the system provided by the employer, whereupon a set of employee check-in and check-out data is created.

The automation of payroll preparation gives employers the ability to streamline budgeting and hiring processes. A wide variety of methods have been implemented to monitor employee arrival and departure, and execute payroll. However, the current methods of capturing and verifying this employee check-in and check-out data are unable to fulfill the objective of generating verified reports, which can be used as evidence of an employee's work history and constitute a business record. Also, many available methods use the collection of biometric data, such as DNA or a fingerprint, as the basis for the verification of their data capture. The collection of this type of data is problematic in terms of the privacy rights of the employees using the system. Therefore, the collection of biometric data will preclude the employer from using the collected employee check-in and check-out data to generate verified reports which can be used and disseminated freely as business records.

Smartphones, tablet devices, desktop computers, and laptop computers are equipped with cameras, touch screens and touch pads. All of these devices also have the ability to transmit data over a wireless internet connection. Since these devices are practically ubiquitous in every employment setting, the ability to collect and transmit employee check-in and check-out data, verified by employee self-photographs and employee signatures, is assured across all job sectors. Employee check-in and check-out data, which is created upon login and verified by a self-photograph, can constitute what may be termed “login event data” for each employee. Using these devices, which are already commonly available to all of us in the workplace, to collect the relevant data, provides a simple and effective solution to the problem of how to conduct employee tracking and time management effectively.

The prior art is lacking an ability to account for an employee who works over multiple locations throughout the day or the week. The prior art is also lacking an ability to track the employee check-in and check-out data of numerous employees working at multiple locations, and to generate payments according to overtime schedules and reports based on adaptive employee records. Most importantly, the prior art is lacking an ability to incorporate contemporaneous acknowledgments by the employee regarding the accuracy of the information contained in the system.

Existing systems do not have the ability to capture data by individual employees reliably and with verification. These systems do not create records with acknowledgments from the employee, conclusively establishing the correctness of the information, such as the fact that an employee's pay was received in full. These current systems are not in a language that the employee can understand, and they are not adequate to meet the threshold of record-keeping requirements that must be maintained by employers. Basically, the prior art is lacking an ability to create acceptable legal and business records based on the employee data that is available for capture to the currently available systems.

In order to meet the expectations of employers who are managing a modern-day work force, a computerized employee time-tracking system must be versatile and comprehensive. Employers require an alert process in order to provide the employer with knowledge of important events, such as the fact that a pay request report has been approved by an employee. Employers also require processes that are confirmed separately, such as having both the employee and the employer independently confirm that pay was taken by the employee. The prior art is lacking ability on both of these fronts, since most available systems are simple in nature, being easily defeated without much scrutiny. This is evident in the cases of systems using a time card or a single pin, which do not perform verification by self-photograph and signature. Also, these systems cannot be used outside of a given region because they were not created in a manner that is flexible to variations in local, state, and federal laws with regards to pay rates, overtime rates, and pay bonuses.

### BRIEF SUMMARY OF INVENTION

The present invention is directed to a system and method for creating verified and acknowledged digital employment business records. The system comprises a computer server linked to a database, the computer server comprising a primary processor. A host-specific set of program instructions runs on the primary processor to receive times of check-in and check out for an employee at a worksite and associated self-photographs of that employee as a set of login event data. The primary processor then processes the login event data before adding it to an adaptive record for the employee. The primary processor also processes confirmation data from the employee before adding it to the adaptive record for the employee.

The system further comprises an employee device having a screen, a memory, an image-capturing mechanism, a touch-sensitive input mechanism, and a secondary processor. An employee-specific set of program instructions runs on the secondary processor to create and send a set of login event data to the computer server at the time of employee check-in and check-out. The employee-specific set of program instructions also runs on the secondary processor to create a set of confirmation data in response to a query generated by the computers server.

The system further comprises an employer device having a tertiary processor. An employer-specific set of program instructions runs on the tertiary processor, whereby the employer device may access the login event data sent to the computer by the employee device and send requests to the system for the generation of myriad reports pertaining to a wide variety of human resources issues.

Many commonly available types of computers can be configured to act as a computer server, or one can use a computer that is more specialized for that role. Most laptop computers, desktop computers, tablet devices, and smartphones can be configured to act as an employee device or an employer device.

The self-photographs of the employee that are captured by the system serve as evidence of the fact that the employee was the individual who arrived to and departed from the job site, satisfying the obligations of his or her shift work shift. Furthermore, the signatures of the employee that are captured as verifications of the reports generated by the system, establish the truth, accuracy and validity of the information contained therein from the employee's perspective. After a pay request report is generated by the system at the behest of the employer, the employee reviews the contents of the report before submitting his or her signature in approval. The employer can send requests to the computer for the generation of reports which pertain to a wide variety of personnel issues, including employee compliance, wage rates and disciplinary matters.

The system has the ability to generate reports that satisfy the requirements of state and federal laws with regards to reporting requirements. Due to the manner in which employee login event data is verified by both the employee and the employer within the system, employees who use the system cannot dispute the fact that they have been paid properly and fairly by their employer. Therefore, the verified and acknowledged digital employment business records generated by the system can be used to address audits, be used as evidence in legal proceedings, and be used to foster the security and well-being of the employees and employers using the system.

### BRIEF DESCRIPTION OF THE DRAWINGS

In the detailed description of the preferred embodiments presented below, reference is made to the accompanying drawings.

FIG. 1 is a schematic flow diagram depicting the interactions of the employee when interfacing with the computer server using an employee device.

FIG. 2 is a schematic flow diagram depicting the interactions of the employer when interfacing with the computer server using an employer device.

FIG. 3 is a schematic flow diagram depicting the creation of login event data upon employee check-in and check-out for later access by the employer with the employer device.

FIG. 4 is a schematic diagram detailing how the system is used by the employee when the work week has ended or when the employee is requesting payment at the end of a date range encompassed by the pay request.

FIG. 5 is a schematic diagram detailing the process with which the employee acknowledges pay information and makes requests for pay via the system.

FIG. 6 is a schematic flow diagram detailing possible interactions that an employee may have with the system, including the process that the employee uses to simultaneously verify the accuracy of all the required information.

FIG. 7 is a schematic flow diagram detailing the manner in which the primary processor, the secondary processor and the tertiary processor interact, transmitting data to, and from, both employers and employees.

FIG. 8 is an example of a “Pay Requests” details report generated by the system in response to a pay request, with confirmation provided through self-photograph and signature.

### DETAILED DESCRIPTION OF THE INVENTION

Reference is now made to the embodiments of the method and device for creating verified and acknowledged digital business records. The examples of the embodiments are presented in the accompanying drawings, with reference numerals representing the elements of the invention. The description of the embodiments follows using the figures for reference, in order to explain the invention.

The present disclosure describes a system that employs a computer server and other connected devices for the purposes of capturing and storing data pertaining to the times that individual employees arrive to and depart from work. After its collection, an employer may use the system to generate verified and acknowledged digital employment business records from the data. A computer server has the ability to run applications, process large amounts of data, and store that data in a database for safekeeping. Computer servers can take a variety of forms, including web-based, cloud-based, and localized file servers. A computer server allows users to share information over a network without having to physically transfer files by some external storage device.

Smartphones, tablet devices, laptop computers, and desktop computers use computer processors to run operating systems and other applications. These modern-day devices have the ability to capture, and then transmit, a wide variety of data through either a local area network or a wide area network, like the internet. Due to their versatility and accessories, smartphones, tablets, laptops computers and desktop computers can collect large amounts of diverse data when acting as client devices communicating with a computer server. In the client-server model, a computer server is a computer responsible for controlling the central storage and management of data files so that other computers on the same network can access those files. Almost any computer can be configured to be a host and act as a computer server. Similarly, most laptop computers, desktop computers, tablets, and smartphones can be configured to act as a client device.

In the present invention, users may access the data on the computer server via a compatible device which is connected directly, or remotely, to the computer server. By linking a computer server with a client device having a processor with an employee-specific set of program instructions set up on it, the present invention utilizes what may be termed an “employee device.” Similarly, by linking a computer server with a client device having a processor with an employer-specific set of program instructions set up on it, the present invention utilizes what may be termed an “employer device.” By using a system where employee devices and employer devices interface with a computer server, employees and employers can use many universal modern-day devices in order to collect critical data on employees, especially with reference to the time that employees spend at each work site. This data can be used to facilitate payments, make decisions regarding the retention of employees, and address audits and legal actions, confirming that the employer has adhered to all applicable laws, rules, and regulations.

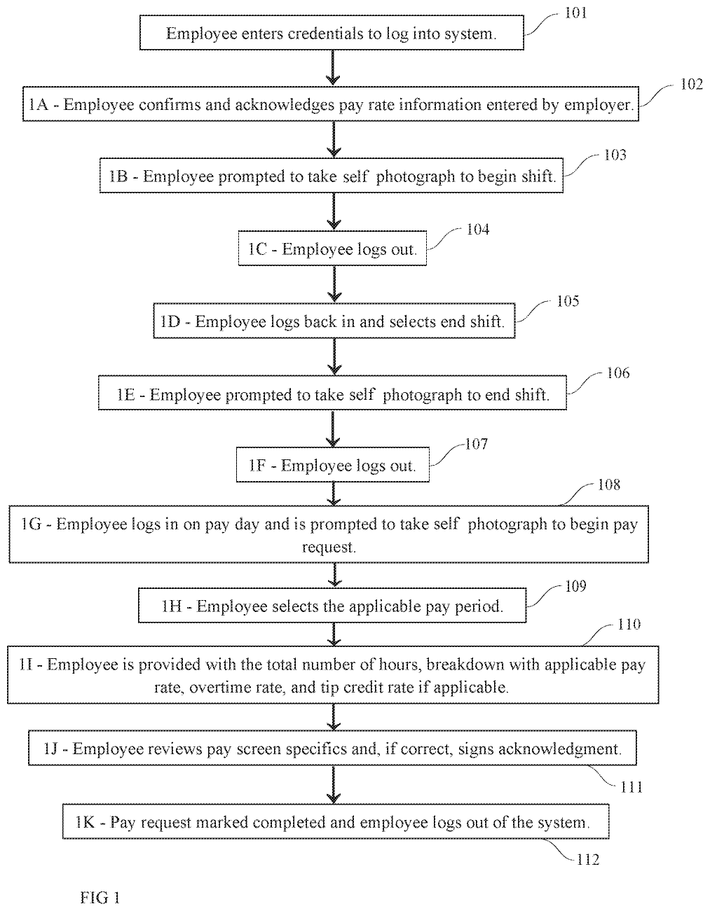

FIG. 1 illustrates how the employee accesses and interacts with the system using an employee device. Using the employee device, the employee will enter credentials into the system 101, thereafter confirming and acknowledging pay rate information entered by employer 102. The employee is then prompted to take a self-photograph to begin his or her shift 103. The employee then logs out of the system before starting the work day 104. The employee will log back into the system at the end of the shift and select the “End Shift” parameter on the client device 105. The employee is then prompted to take a self-photograph to end the shift 106, and he or she logs out of the system 107.

The employee logs in on pay day and is prompted to take a self-photograph to begin the pay request process 108. In the next step, the employee selects the applicable pay period 109, and he or she is then provided with the total number of hours, breakdown with applicable pay rate, overtime rate, and tip credit rate, if applicable 110. The employee reviews pay screen specifics and, if correct, signs the acknowledgment 111. Finally, the pay request is marked “Completed” by the employee and he or she logs out of the system 112.

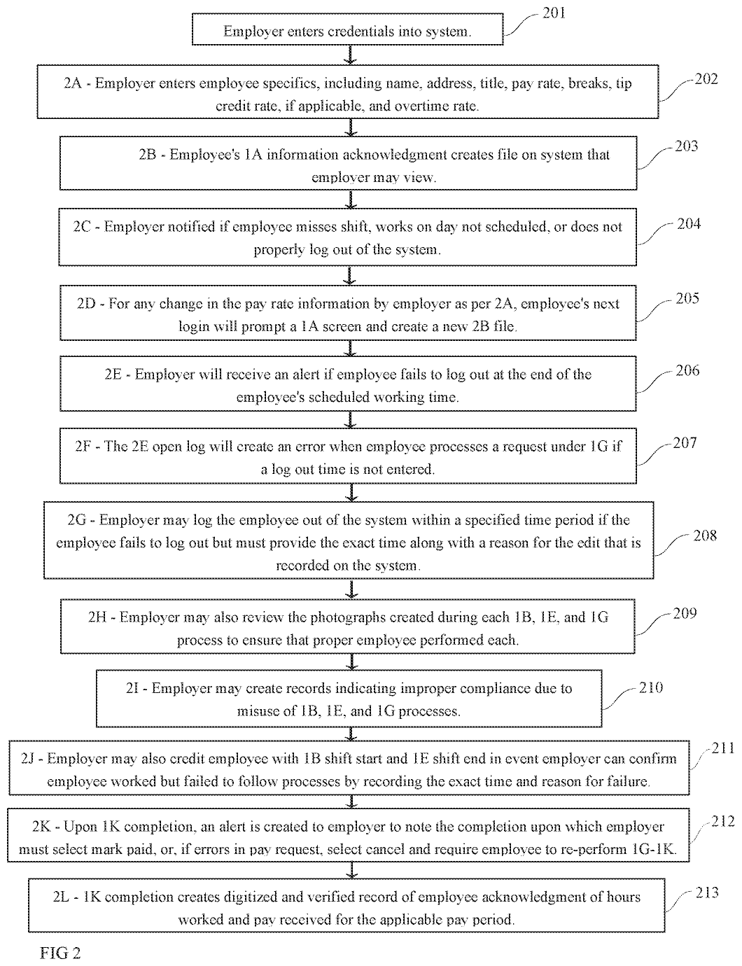

FIG. 2 illustrates how the employer accesses and interacts with the system using an employer device. Using the client device, the employer will enter credentials into the system 201, including employee specifics, such as employee name, address, title, pay rate, breaks, work schedule, deductions or credits, tip credit rate, if applicable, and overtime rate 202. The system then creates the profile of the employee, as well as a password, pin, or code for the given employee. The acknowledgment made after this data capture creates a record on the computer server operated by the primary processor, which the employer may later view on the employer device 203. Thereafter, the employer is notified if the employee misses a shift or does not properly log out of the system 204.

When there are any changes in the pay rate information made by employer, the employee will be presented with a pay rate confirmation screen at login, which will create a record regarding the new acknowledgment 205 and store the record in the database connected to the computer server. The employer will receive an alert if employee fails to log out at the end of the employee's scheduled work shift 206. The system will then generate an error report when the employee does not log out properly 207. However, the employer may log the employee out of the system within a specified time period if the employee fails to log out, where the employer provides the logout time and a reason that the logout of the employee was not properly performed 208.

The employer may also review the self-photographs which are created the during the employee login process, the employee logout process and the employee pay request process 209. These self-photographs are generated and collected when an employee is prompted to take photographs of himself or herself by the system. The employer may create records indicating improper compliance due to misuse of the self-photograph confirmation process 210. Also, the employer can credit an employee with login and logout events on the system and record an employee's failure to follow processes, performing this action when the employer confirms that an employee worked, but failed to follow the processes prescribed by the system 211.

When an employee completes the login and logout process, an alert is created for the employer to note the completion, whereupon employer must select “Mark Paid,” or, if there are errors in the pay request, the employer can select “Cancel” and require the employee to repeat the process 212. When the pay request is marked “Completed” and the employee logs out of the system, the interaction creates a digitized and verified record of the employee acknowledgment of the number of hours that the employee worked, and the pay that the employee received for the applicable pay period 213.

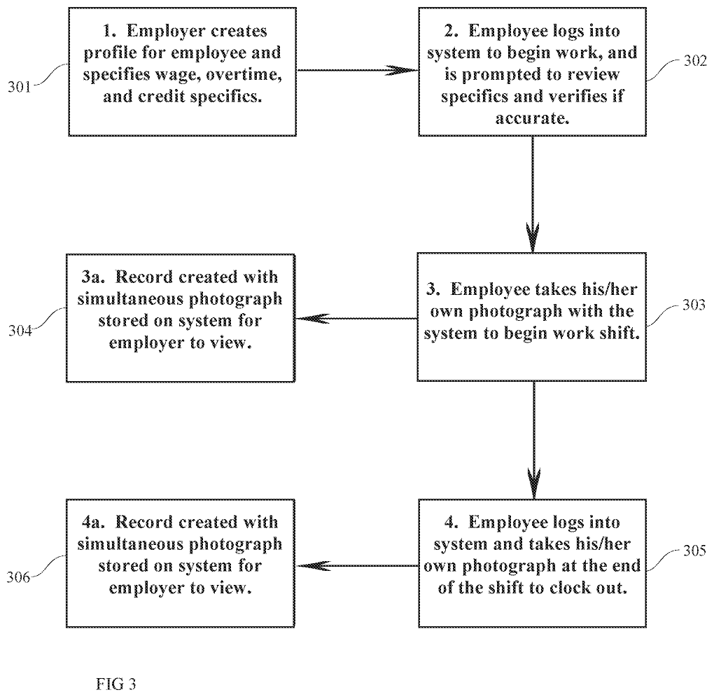

FIG. 3 depicts the creation of login event data upon employee check-in and check-out for later access by the employer with the employee device. The interactions of the employer are captured within the framed boxes on the left side of FIG. 3 (301, 304, 306), whereas the interactions of the employee are captured within the framed boxes on the right side of the figure (302, 303, 305). Initially, the employer creates a profile for the employee and specifies wage, overtime, and credit specifics 301. Then, the employee logs into the system to begin work and is prompted to review the collected data and verify if it is accurate 302. This action is followed by the employee taking his or her photograph with the employee device before beginning the work shift 303. At this point, a record is created with a simultaneous self-photograph which is transmitted, processed, and stored on the system 304. This record is available to the employer immediately after processing via the computer server. At the end of the work shift, the employee logs into the system and takes a self-photograph in order to end his or her shift 305. After the capture of this data, a record is created with a simultaneous self-photograph 306. This record is processed by the system and made readily available to the employer, who may access it with the employer device.

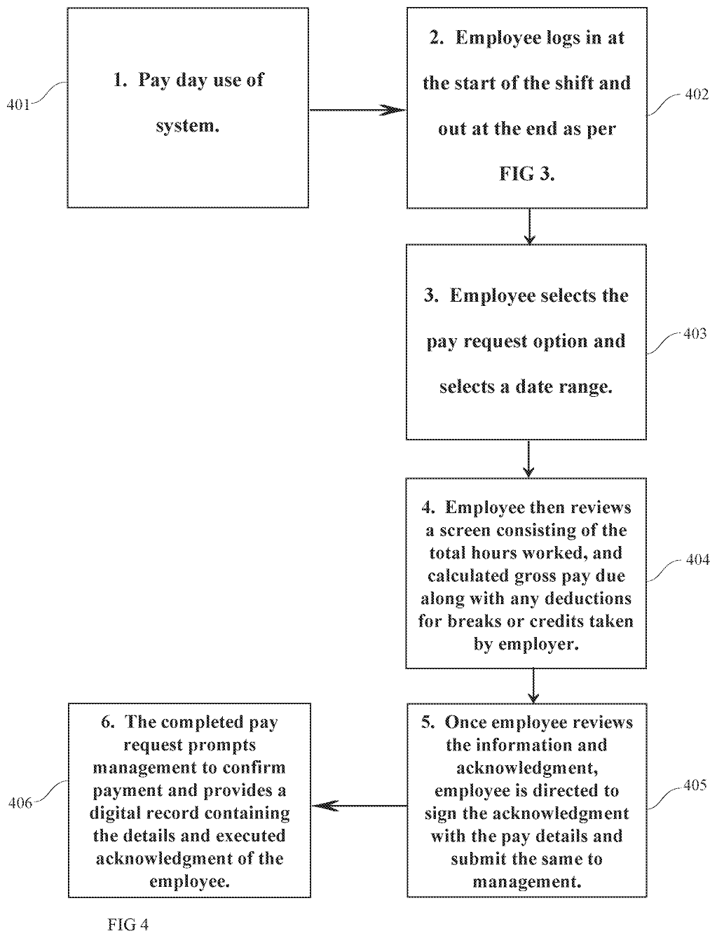

FIG. 4 details the process used by the employee on pay day 401. This process may be used when the work week has ended or when the employee is requesting payment at the end of a date range encompassed by the pay request. The employee uses the system as he or she usually does, logging in at the start and at the end of his or her work shift through the employee device 402. The system compels the employee to take a self-photograph after logging into the system at the beginning of his or her shift 303. The system compels the employee to perform the same action, taking a self-photograph at the end of his or her shift 305. The self-photographs, and the starting and ending times of each employee's shifts, are captured by the system during the interactions between the employees and the system.

Thereafter, the employee selects the pay request option and selects a date range 403. The employee then reviews the pay request, which includes the employee's pay rates, overtime rates, tip credits, if applicable, total hours worked, days worked, and time worked in each of the days in the set period, as well as the total gross pay due to the employee 404. Once employee reviews the information and acknowledgment, the employee is directed to sign the acknowledgment with the pay details and submit the same to management 405. The completed pay request prompts management to confirm payment, and provides a digital record containing the details and executed acknowledgment of the employee 406.

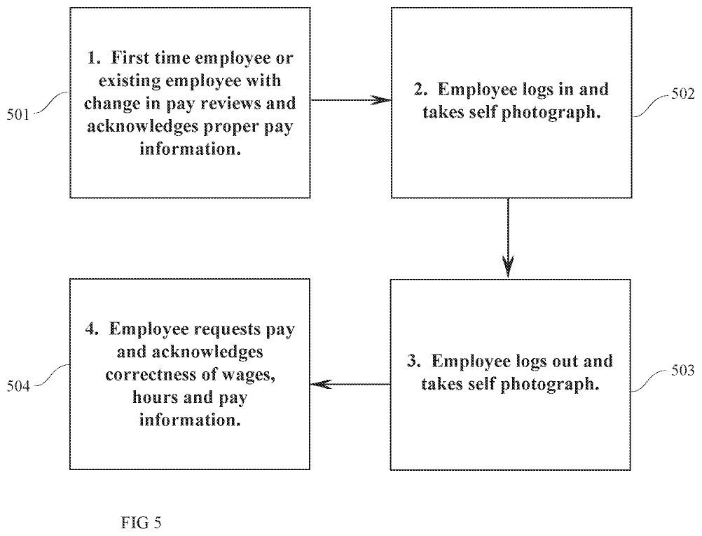

FIG. 5 details the typical interactions that the employee will have with the system when the employee is acknowledging pay information and making a request for pay with the employee device. The first-time employee, or existing employee who has a change in pay, reviews and acknowledges that the proper pay information has been entered into the system 501. The employee then logs in and takes a self-photograph 502. Thereafter, the employee logs out and takes a self-photograph 503. As a confirmation step of the process, the employee requests pay and acknowledges the correctness of wages, hours, and pay information 504.

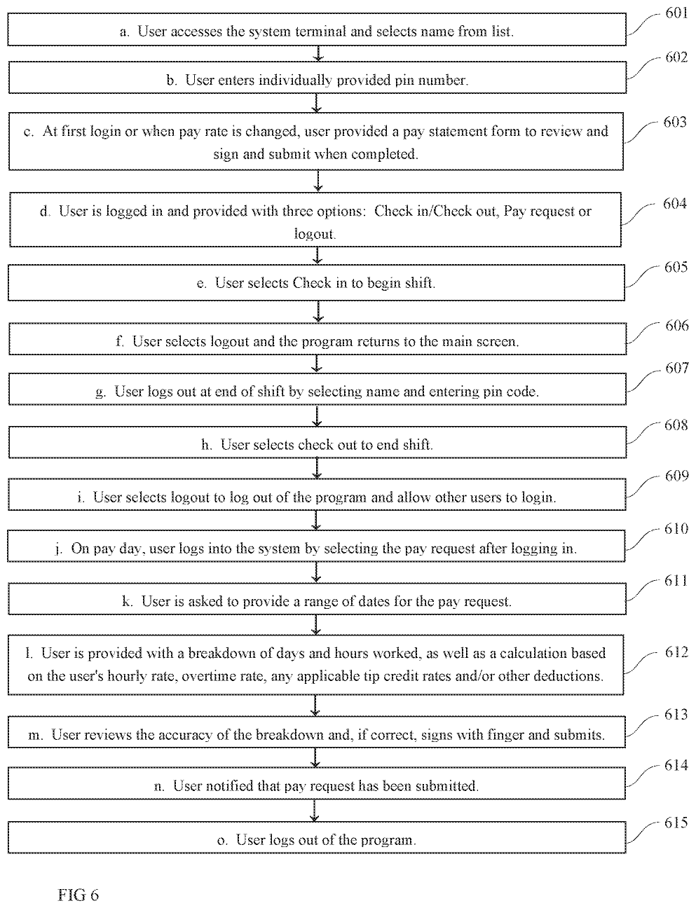

FIG. 6 details all the possible interactions that an employee may have with the system, including the process that the employee uses to simultaneously verify the accuracy of all the required information. Initially, the employee accesses the employee device and selects his or her name from the list 601. The employee then enters the password, pin number, or code that was previously, and individually, provided to the employee 602. If it is the employee's first time logging in, or the employee's first time logging in after a change in pay, the employee will be prompted to review the information provided by the employer and, upon deciding that the information is correct, to sign by finger touch. The system instantly creates and stores a digital record of the interaction and the associated verification.

At the times of first login, and when the pay rate is changed for the employee, the employee is provided with a pay statement form to review, sign and submit upon completion 603. The employee is then logged into the system and provided with three options: “Check In/Check Out,” “Pay Request” and “Logout” 604. The employee selects “Check In” to begin shift 605 and, after completing that interaction with the system, he or she selects “Logout” and the program returns to the main screen 606. The employee then logs in at the end of his or her shift by selecting his or her name, and entering the aforementioned password, pin number, or code 607. The employee selects “Check Out” to end shift 608, and then selects “Logout” to log out of the system and allow other users to interact with the system 609.

On pay day, the employee logs into the system and selects the pay request option after logging in 610. The employee is asked to provide a range of dates for the pay request 611. He or she is then provided with a breakdown of days and hours worked, as well as a calculation based on the user's hourly rate, overtime rate, any applicable tip credit rates, and other deductions 612. Finally, he or she reviews the accuracy of the breakdown, and, if correct, the employee signs with his or her finger and makes the submission 613. After this confirmation, the employee is notified that the pay request has been submitted 614. He or she then logs out of the system, and the employee interaction is completed 615, since all data collection and verification parameters have been satisfied.

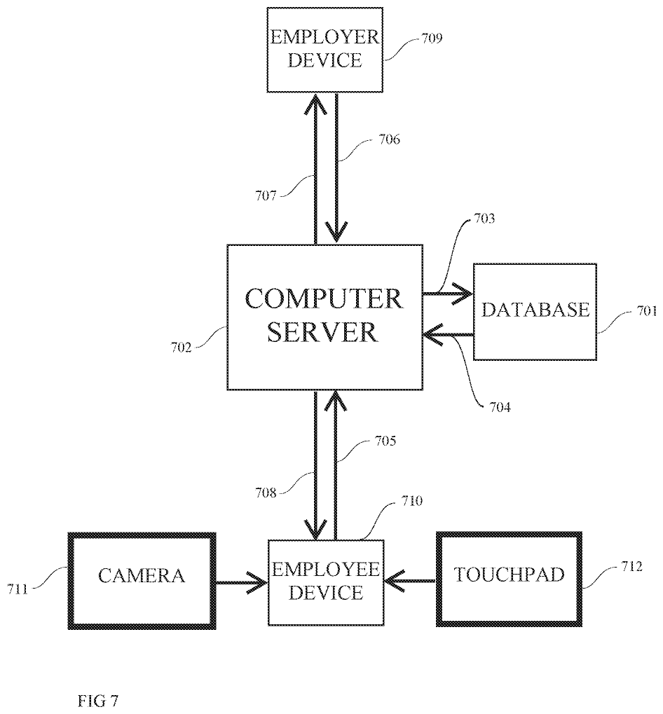

FIG. 7 details the manner in which the primary processor, the secondary processor and the tertiary processor interact, transmitting data to and from both the employer and the employees through the system. The system comprises a computer server 702 with an accompanying database 701. The computer server communicates and stores employee login event data, as well as employee profiles, on the connected database 703. The computer server may also access data and compile reports based on the data stored in the attached database 704.

The system further comprises a number of client devices communicating with the computer server. The client device may take the form of an employer device 709 or it may take the form of an employee device 710. The computer server, comprising a primary processor, receives employee profiles and employee login event data, which includes times of departure and arrival for each employee's work shift, employee self-photographs, and confirmations from the employees, indicating that the information transmitted to and stored in the database is correct 705. The computer server sends queries to the employee device for confirmations from the employees 708. The employee device comprises a secondary processor, an employee-specific set of program instructions, set up on the employee device, that, when executed, directs the employee device to collect employee login event data, personnel information, and employee confirmations, storing them on the employee device before transmitting the data to the computer server 705, which stores the data in the database 703.

The employer device comprises a tertiary processor, an employer-specific set of program instructions, set up on the employee device, that, when executed, directs the employer device to permit an employer to submit employee profiles and requests for reports 706 and to access login event data processed on the computer server and stored in the database 707. These reports pertain to a wide variety of personnel issues, including employee compliance, wage rates and disciplinary matters. Similarly, the secondary processor is programmed to permit an employee to confirm that the collected information is correct and to derive other types of information from the system, such as status reports and updates to the employee's profile 708.

In order to effectuate login event data collection, the employee device is equipped with a camera or cameras 711, which enable the gathering of self-photographs, and a touch-pad or touch-screen 712, which enables the gathering of employee confirmations through touch-pad selections and employee signatures. Self-photographs and employee signatures are saved on the employee device 710, before being transmitted 705 to the computer server 702, which processes the information and saves it 703 in the database 701. The computer server transmits processed information to the tertiary processor in the form of reports, including payroll reports, attendance reports, and employee profile reports, where it is readily accessible 707.

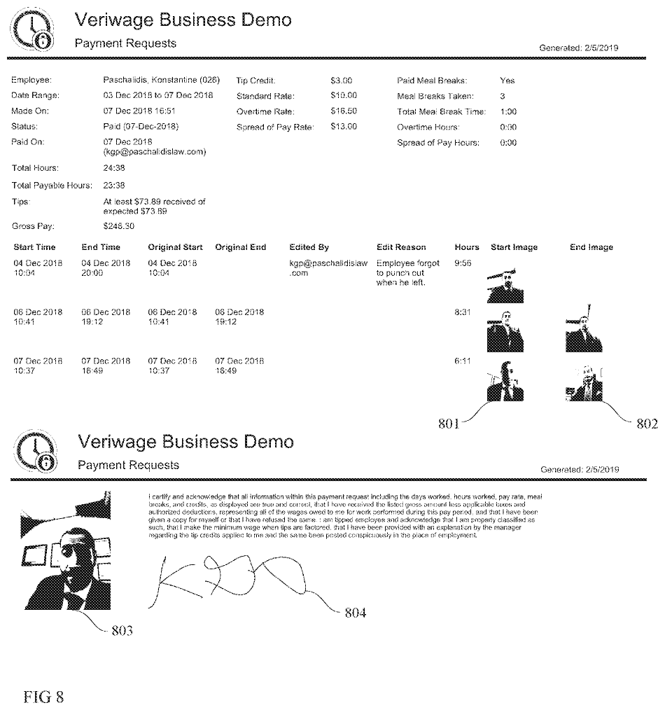

FIG. 8 provides an example of a “Pay Requests” details report generated by the system in response to a pay request. The “Pay Requests” details report includes self-photographs captured at the time that the employee logged in to start his or her work shift 801, and self-photographs captured at the time that the employee logged out to end his or her work shift 802. Verification is effectuated through the capture of both a self-photograph 803 and signature 804. The distribution of relevant login event data is presented by the “Pay Requests” details report in a manner which is concise, readily accessible, and, most importantly, correct and precise.

When first registering the business with the system, the employer is permitted to set certain functions, in order to be compliant with local labor laws in the jurisdiction where the employer is operating. For example, the employer can set the overtime rate in cases where the state's rate or the company's rate is more than one and a half times the standard hourly pay rate. Or the employer may set the overtime rate by the day, in addition to setting the overtime rate by the week.

Also, the employer may invoke certain parameters set by state laws, rules, and regulations by entering the location of the business. This action incorporates factors, such as the daily and weekly rates for overtime in the State of California or the spread-of-hours pay bonus in New York State, enabling the management of personnel in any particular locale. The versatility of the system makes it indispensable to employers and their human resources teams, who require the tracking of personnel across many locations and jurisdictions.

Since the employee login event data is verified by both the employee and the employer, the reports generated by the system satisfy state and federal laws, and they may be submitted to government agencies. Thus, the inability of other systems in the prior art is satisfied by this method and device, which produces verified and acknowledged digital employment business records which may be used to address audits, be presented as evidence in legal proceedings, and be used to foster the security and well-being of the employees and employers using the system.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method of creating verified and acknowledged digital employment business records for an employee on a computer server comprising:
interfacing, via the computer server, with an employee device;
interfacing, via the computer server, with an employer device;
receiving, via the computer server, a set of identifying information for the employee;
creating, via the computer server, an adaptive record for the employee using the set of identifying information for the employee;
receiving, via the computer server, a set of employment details for the employee;
processing, via the computer server, the set of employment details to produce an employer set of granular data;
integrating, via the computer server, the employer set of granular data into the adaptive record for the employee;
receiving, via the computer server, a set of login event data for a work shift for the employee;
processing, via the computer server, the set of login event data to produce a first set of granular data;
integrating, via the computer server, the first set of granular data into the adaptive record for the employee;
generating, via the computer server, a query based on the adaptive record for the employee;
transmitting, via the computer server, the query to the employee;
receiving, via the computer server, a set of acknowledgment data from the employee or a denial of the query;
requiring, via the computer server, a subsequent query generation upon receiving the denial of the query;
sending, via the computer server, an alert to the employer upon receipt of the set of acknowledgment data from the employee;
processing, via the computer server, the set of acknowledgment data to produce a second set of granular data;
integrating, via the computer server, the second set of granular data into the adaptive record; and
distributing, via the computer server, a number of regular-pay hours and a number of overtime-pay hours as mixed numbers or decimals to the work shift based on the adaptive record for the employee.

2. The method of claim 1 wherein the step of receiving, via the computer server, a set of login event data for a work shift for the employee further comprises the steps of:
receiving, via the computer server, a first set of time-stamp data for the employee for a time of check-in at a work site;
receiving, via the computer server, a first self-photograph of the employee for the first set of time-stamp data;
receiving, via the computer server, a second set of time-stamp data for the employee for a time of check-out at the work site;
receiving, via the computer server, a second self-photograph of the employee for the second set of time-stamp data;
assembling, via the computer server the first set of time-stamp data, the first self-photograph, the second set of time-stamp data, and the second self-photograph together into a set of login event data;
transmitting, via the computer server, the set of login event data to the computer server;
comparing, via the computer server, the set of login event data to a model set of login event data;
identifying, via the computer server, an improperly collected set of login event data;
sending, via the computer server, an alert to the employer for the improperly collected set of login event data;
receiving, via the computer server, a set of completion data from the employer to supplement the improperly collected set of login event data for the employee;
processing, via the computer server, the set of completion data into a third set of granular data;
integrating, via the computer server, the third set of granular data into the adaptive record for the employee;
generating, via the computer server, an error report for the improperly collected set of login event data.

3. The method of claim 2 wherein the step of distributing, via the computer server, a number of regular-pay hours and a number of overtime-pay hours as mixed numbers or decimals to the work shift based on the adaptive record for the employee further comprises the step of:
distributing, via the computer server, a number of hours for paid time off to the work shift as mixed numbers or decimals based on the adaptive record for the employee for sick days, vacation days, and personal days.

4. The method of claim 2 wherein the step of generating, via the computer server, a query based on the adaptive record for the employee further comprises the steps of:
applying, via the computer server, a set of overtime parameters to the adaptive record for the employee;
generating, via the computer server, a pay request report based on the set of overtime parameters and the adaptive record for the employee.

5. The method of claim 2 wherein the step of generating, via the computer server, a query based on the adaptive record for the employee further comprises the steps of:
applying, via the computer server, a set of comprehensive parameters to the adaptive record for the employee;
generating, via the computer server, a comprehensive report based on the set of comprehensive parameters and the adaptive record for the employee.

6. The method of claim 2 wherein the step of generating, via the computer server, a query based on the adaptive record for the employee further comprises the steps of:
applying, via the computer server, a set of compliance parameters to the adaptive record for the employee;
generating, via the computer server, a compliance report which confirms adherence to federal, state and local labor laws.

7. The method of claim 2 further comprising the steps of:
creating, via the computer server, a uniquely generated password for the adaptive record for the employee;
transmitting, via the computer server, the uniquely generated password to the employee;
requiring, via the computer server, the inputting of the uniquely generated password for the employee device to interface with the computer server.

8. A method for using employee login event data captured at the times of check-in and check-out for an employee at a work site to generate comprehensive reports based on an employee profile on a computer server, the method comprising the steps of:
connecting, by the computer server, to an employee device;
connecting, by the computer server, to an employer device;
receiving, by the computer server, a set of personnel data for the employee;
creating, by the computer server, an employee profile with the set of personnel data;
receiving, by the computer server, an additional set of personnel data for the employee;
adding, by the computer server, the additional set of personnel data to the employee profile;
receiving, by the computer server, a set of login event data for the employee;
adding, by the computer server, the set of login event data to the employee profile;
receiving, by the computer server, an additional set of login event data for the employee;
adding, by the computer server, the additional set of login event data to the employee profile;
generating, by the computer server, a query based on the employee profile;
receiving, by the computer server, a set of confirmation data for the query or a denial of the query;
requiring, by the computer server, a subsequent query generation upon receiving the denial of the query;
adding, by the computer server, the set of confirmation data to the employee profile; and
distributing, by the computer server, a number of regular-pay hours and a number of overtime-pay hours as mixed numbers or decimals to the work shift based on the employee profile.

9. The method of claim 8 wherein the step of receiving, by the computer server, a set of login event data for the employee further comprises the steps:
receiving, by the computer server, a time of check-in for a work shift and a first self-photograph of the employee;
receiving, by the computer server, a time of check-out for the work shift and a second self-photograph of the employee;
creating, by the computer server, a set of login event data for the work shift by collating the time of check-in, the first self-photograph, the time of check-out, and the second self-photograph;
comparing, by the computer server, the set of login event data to a model set of login event data;
sending, by the computer server, an alert when an incomplete set of login event data is identified;
receiving, by the computer server, a set of completion data;
generating, by the computer server, an error report for the incomplete set of login event data.

10. The method of claim 8 wherein the step of distributing, by the computer server, a number of regular-pay hours and a number of overtime-pay hours to the work shift based on the employee profile further comprises the step of:
distributing, by the computer server, a number of hours for paid time off to the work shift as mixed numbers or decimals based on the employee profile for sick days, vacation days, and personal days.

11. The method of claim 8 wherein the step of generating, by the computer server, a query based on the employee profile further comprises the steps of:
applying, by the computer server, a set of overtime parameters to the employee profile;
generating, by the computer server, a pay request report based on the set of overtime parameters and the employee profile.

12. The method of claim 8 wherein the step of generating, by the computer server, a query based on the employee profile further comprises the steps of:
applying, by the computer server, a set of comprehensive parameters to the employee profile;
generating, by the computer server, a comprehensive report based on the set of comprehensive parameters and the employee profile.

13. The method of claim 9 further comprising the steps of:
creating, by the computer server, a uniquely generated password for the employee profile;
transmitting, by the computer server, the uniquely generated password to the employee;
requiring, by the computer server, the inputting of the uniquely generated password for access to the employee profile.

14. A system for creating verified and acknowledged digital employment business records for an employee comprising:
an employee device comprising a secondary processor, a screen, a memory, an image-capturing mechanism, and a touch-sensitive input mechanism;
a computer server connected to the employee device, the computer server comprising a primary processor, with a linked database, executing a host-specific set of program instructions;
an employee-specific set of program instructions, set up on the employee device, that, when executed, directs the employee device to:
interface with the computer server;
receive a set of identifying information for an employee into the memory of the employee device;
send the set of identifying information for the employee to the computer server;
create a set of time-stamp data for a work shift for the employee into the memory of the employee device;
create a set of self-photographs for the employee with the image-capturing mechanism for the employee into the memory of the employee device;
create a set of login event data for the employee by assembling the set of time-stamp data and the set of self-photographs together;
send the set of login event data for the employee to the computer server;
receive a query generated by the computer server;
present the query graphically on the screen for review by the employee;
create a set of one self-photograph from the image-capturing mechanism into the memory of the employee device upon approval of the query;
create a set of one signature from the touch-sensitive input mechanism into the memory of the employee device upon approval of the query;
create a set of acknowledgment data by assembling the set of one self-photograph and the set of one signature together upon approval of the query;
send the set of acknowledgment data to the computer server upon approval of the query;
create a denial of the query upon denial of the query;
send the denial of the query to the computer server;
the host-specific set of program instructions, set up on the computer server, that, when executed, further directs the computer server to:
interface with the employee device;
receive the set of identifying information for the employee;
create an adaptive record for the employee;
receive the adaptive record for the employee into the database;
receive the set of login event data for the employee from the employee device;
process the set of login event data for the employee into a first set of granular data;
integrate the first set of granular data into the adaptive record for the employee;
receive a request for a query;
generate the query;
receive the set of acknowledgment data from the employee device upon approval of the query;
process the set of acknowledgment data into a second set of granular data upon approval of the query;
integrate the second set of granular data into the adaptive record for the employee upon approval of the query;
receive the denial of the query upon denial of the query;
require a subsequent query generation upon receiving the denial of the query; and
distribute a number of regular-pay hours and a number of overtime-pay hours as mixed numbers or decimals to the work shift based on the adaptive record for the employee.

15. A system as recited in claim 14 wherein the employee-specific set of program instructions, set up on the employee device, that, when executed by the secondary processor, further directs the computer server to:
create an additional set of time-stamp data for a work shift for the employee into the memory of the employee device;
create an additional set of self-photographs for the employee with the image-capturing mechanism for the employee into the memory of the employee device;
create an additional set of login event data for the employee by assembling the additional set of time-stamp data and the additional set of self-photographs together;
send the additional set of login event data for the employee to the computer server;
the host-specific set of program instructions, set up on the computer server, that, when executed, further directs the computer server to:
interface with the employee device;
receive the additional set of login event data for the employee from the employee device;
process the additional set of login event data for the employee into an additional first set of granular data;
integrate the additional first set of granular data into the adaptive record for the employee.

16. A system as recited in claim 15 further comprising: an employer device connected to the computer server;
an employer-specific set of program instructions, set up on the employer device, that, when executed by a tertiary processor, directs the employer device to:
interface with the computer server;
receive a set of employee details for the employee;
send the set of employee details for the employee to the computer server for processing and integration into the adaptive record for the employee;
access the set of login event data collected for the employee;
compare the set of login event data to a model set of login event data;
identify an improperly collected set of login event data;
display a first alert for the improperly collected set of login event data;
send a request for an error report to the computer server;
receive a set of completion data from the employer to supplement the improperly collected set of login event data for the employee;
send the set of completion data to the computer server;
receive an acknowledgment alert when the computer server receives the set of acknowledgment data;
display the acknowledgment alert;
send a request for a query to the computer server;
send a set of parameters to the computer server;
the host-specific set of program instructions, set up on the computer server, that, when executed, further directs the computer server to:
interface with the employer device;
receive the set of employee details for the employee;
process the set of employee details for the employee into a third set of granular data;
integrate the third set of granular data into the adaptive record for the employee;
receive the request for an error report for the improperly collected set of login event data;
generate an error report for the improperly collected set of login event data;
receive the set of completion data;
process the set of completion data into a fourth set of granular data;
integrate the fourth set of granular data into the adaptive record for the employee;
create the acknowledgment alert when the set of acknowledgment data is received;
send the acknowledgment alert to the employer device;
receive the set of parameters.

17. A system as recited in claim 16 wherein the host-specific set of program instructions, set up on the computer server, that, when executed by a primary processor, further directs the computer server to:
distribute a number of hours for paid time off to the work shift based on the adaptive record for the employee for sick days, vacation days, and personal days.

18. A system as recited in claim 16 wherein the employer-specific set of program instructions, set up on the employer device, that, when executed by the tertiary processor, further directs the employer device to:
send a set of overtime parameters to the computer server;
send a set of instructions to apply the set of overtime parameters to the adaptive record for the employee;
the host-specific set of program instructions, set up on the computer server, that, when executed, further directs the computer server to:
receive the set of overtime parameters;
receive the set of instructions to apply the set of overtime parameters to the adaptive record for the employee;
apply the set of overtime parameters to the adaptive record for the employee;
generate a pay request report based on the set of overtime parameters and the adaptive record for the employee.

19. A system as recited in claim 16 wherein the employer-specific set of program instructions, set up on the employer device, that, when executed by the tertiary processor, further directs the employer device to:
send a set of comprehensive parameters to the computer server;
send a set of instructions to apply the set of comprehensive parameters to the adaptive record for the employee;
the host-specific set of program instructions, set up on the computer server, that, when executed, further directs the computer server to:
receive the set of comprehensive parameters;
receive the set of instructions to apply the set of comprehensive parameters to the adaptive record for the employee;
apply the set of comprehensive parameters to the adaptive record for the employee;
generate a comprehensive report based on the set of comprehensive parameters and the adaptive record for the employee.

20. A system as recited in claim 16 wherein the host-specific set of program instructions, set up on the computer server, that, when executed, further directs the computer server to:
create a uniquely generated password for the adaptive record for the employee;
transmit the uniquely generated password to the employee device;
receive the uniquely generated password for the employee device to interface with the computer server and access the adaptive record for the employee.
